(19) United States
(12) Patent Application Publication
(10) Pub. No.: US 2021/0000294 A1
(43) Pub. Date: Jan. 7, 2021

(54) SECURITY SYSTEM FOR GAS FUELED DEVICES

(71) Applicant: Fire Lock LLC, Millersville, MD (US)

(72) Inventors: Kevin Fox, Severna Park, MD (US); Michael Simpson, Bowie, MD (US)

(21) Appl. No.: 16/900,346

(22) Filed: Jun. 12, 2020

Related U.S. Application Data
(60) Provisional application No. 62/860,450, filed on Jun. 12, 2019.

(51) Int. Cl. A47J 37/07; G07C 9/33

(52) U.S. Cl. CPC A47J 37/0786; A47J 37/0713; G07C 9/33

(57) ABSTRACT

A security system for a gas fueled device includes a gas valve and a controller operably coupled to the gas valve. A first end portion of the gas valve is operably coupled to a gas source and a second, opposite end portion of the gas valve is operably coupled to a gas fueled device. The controller includes a processor and a memory. The memory stores instructions, which when executed, cause the processor to request entry of a user code, confirm that the entered user code is authorized for use by comparing the entered user code to a plurality od authorized user codes stored on the memory, and generate a signal to cause the gas valve to open and permit the flow of gas from the gas source to the gas fueled device.

### CROSS-REFERENCE TO RELATED APPLICATION

The present application claims the benefit of and priority to U.S. Provisional Patent Application Ser. No. 62/860,450, filed on Jun. 12, 2019, the entire content of which is hereby incorporated by reference herein.

### TECHNICAL FIELD

The present disclosure relates generally security systems, and in particular, security devices and systems for gas fueled devices.

### BACKGROUND

Many residential communities prohibit the use of gas grills and gas fire pits on decks or balconies due to the risk of fire. Therefore, many of these communities provide communal gas grills and fire pits in common areas (e.g., picnic areas, parks, etc.) for use by residents and their guests. As these communal gas grills and fire pits are often accessible by the general public, whether permitted or otherwise, unsupervised and unauthorized use of the gas grills and fire pits can result in a failure to shut off the gas when leaving, resulting in wasted fuel, fires, explosions, etc.

Such events are not limited to unauthorized users, as residents and other authorized users may likewise be careless. As can be appreciated, it is often difficult to identify the individual or group who last used the gas grill or fire pit and therefore, it is difficult to apportion liability, especially after hours when many management teams have ceased monitoring the premises.

### SUMMARY

The present disclosure relates to a security system for a gas fueled device including a gas valve and a controller. A first end portion of the gas valve is operably coupled to a gas source and a second, opposite end portion of the gas valve is operably coupled to a gas fueled device. The controller is operably coupled to the gas valve and includes a processor operably coupled to a memory. The memory stores instructions, which when executed, cause the processor to request entry of a user code, confirm that the entered user code is authorized for use by comparing the entered user code to a plurality of authorized codes stored on the memory, and generate a signal to cause the gas valve to open and permit the flow of gas from the gas source to the gas fueled device if the entered user code is authorized for use.

In aspects, the gas valve may be a motorized ball valve.

In certain aspects, the controller may be disposed remote from the gas valve.

In other aspects, the controller may include a wireless interface that is configured to selectively communicate with a user device.

In certain aspects, the controller may include a user interface having a display screen.

In aspects, the display screen may be a touch screen.

In certain aspects, the gas fueled device may be selected from the group consisting of a gas grill, a gas fire pit, a gas heater, an indoor gas appliance, and an outdoor gas light.

In other aspects, the instructions stored on the memory associated with the controller may include a run timer, wherein expiration of a predetermined amount of time associated with the run timer causes the processor to generate a signal to cause the gas valve to close and inhibit the flow of gas from the gas source to the gas fueled device.

In aspects, the controller may include a plurality of relays operably coupled to the processor and the gas valve.

In accordance with another aspect of the present disclosure, a method of using a security system for a gas fueled device includes requesting entry of a user code on a controller, comparing the entered user code to a plurality of user codes stored on a memory associated with the controller, confirming that the entered user code is authorized for use, and generating a signal to cause a gas valve operably coupled to the controller to open and permit the flow of gas from a gas source to a gas fueled device if the entered user code is authorized for use.

In aspects, the method may include inhibiting the use of the gas fueled device is the entered user code is not confirmed as being authorized for use.

In other aspects, the method may include requesting re-entry of a user code if the entered user code is not confirmed as being authorized for use.

In certain aspects, the method may include initiating a run timer, wherein expiration of a predetermined amount of time associated with the run timer causes the processor to generate a signal to cause the gag valve to close and inhibit the flow of gas from the gas source to the gas fueled device.

In other aspects, generating a signal to cause the gas valve to open may include generating a signal to cause the gas valve to open and permit the flow of gas from the gas source to a gas grill if the entered user code is authorized for use.

In certain aspects, generating a signal to cause the gas valve to open may include generating a signal to cause the gas valve to open and permit the flow of gas from the gas source to a gas fire pit if the entered user code is authorized for use.

In accordance with another aspect of the present disclosure, a method of using a security system for a gas fueled device includes requesting entry of a user code on a controller, confirming that the entered user code is authorized for use, initiating a run timer if the entered code is confirmed as being authorized for use, generating a signal to cause a gas valve operably coupled to the controller to open and permit the flow of gas from a gas source to a gas fueled device, and generating a signal to cause the gas valve to close and inhibit the flow of gas from the gas source to the gas fueled device at the expiration of a predetermined amount of time associated with the run timer.

In aspects, the method may include inhibiting the use of the gas fueled device if the entered user code is not configured as being authorized for use.

In other aspects, the method may include requesting re-entry of a user code if the entered user code is not confirmed as being authorized for use.

In certain aspects, generating a signal to cause the gas valve to open may include generating a signal to cause the gas valve to open and permit the flow of gas from the gas source to a gas grill if the entered user code is authorized for use.

In aspects, generating a signal to cause the gas valve to open includes generating a signal to cause the gas valve to open and permit the flow of gas from the gas source to a gas firepit if the entered user code is authorized for use.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a perspective view of a security system for use with a gas fueled device provided in accordance with the present disclosure;

FIG. 2 is a perspective view of a control housing of the security system of FIG. 1;

FIG. 3 is a front view of a controller of the security system of FIG. 1;

FIG. 4 is a schematic view of a control board of the controller of FIG. 3; and

FIG. 5 is a flow diagram of the operation of the security system of FIG. 1.

### DETAILED DESCRIPTION

The present disclosure is directed to a security system for gas fueled devices. The security system includes a gas valve and a controller that is operably coupled to the gas valve. The gas valve includes an inlet hose that is operably coupled to a gas source such as a gas bottle or gas line and includes an outlet hose that is operably coupled to a gas fueled device, such as a gas grill, gas firepit, etc. The gas valve is electronically controlled by an electronic relay which is actuated to cause the gas valve to transition from a closed position, inhibiting the flow of gas from the gas source to the gas fueled device, to an open position, permitting the flow of gas from the gas source to the gas fueled device. In embodiments, the gas valve and the electronic relay are disposed in a control housing that is disposed within a portion of the gas fueled device, such as a cabinet or the like.

The controller is located remotely from the gas valve and/or control housing and is operably coupled to the electronic relay. The controller includes a housing that is configured to be disposed within a single gang electrical box or on an exterior portion of the electrical box using an adapter or the like. The controller includes a microprocessor having a memory and a user interface. The user interface includes a display screen which may be a touch screen on which user inputs may be made. The memory stores instructions having various settings and functions. In embodiments, the controller enables an administrator to assign a name to the gas fueled device to which the controller is operably coupled. The controller permits the creation of one or more user profiles including information relating to the resident or individual who is being given access to the gas fueled device, such as one or more of the user's first name, last name, phone number, e-mail address, street address, apartment/suite number, city, state, etc. As can be appreciated, the user profile is given a user access code, such as a 4-digit access code and permits a user to enter an incorrect user code up to 4 times before the controller locks the gas fueled device for a predetermined amount of time before the user may re-enter the user code.

The controller enables a run timer to be set for a predetermined amount of time during which time the user may enjoy uninterrupted use of the gas fired device. At the conclusion of the assigned run time, the run timer will close the gas valve to terminate the flow of gas from the gas source to the gas fueled device. The administrator may assign the same or different run time to each user profile. The controller is configured to store and log events in the memory corresponding to the user code, user name, date and/or time, and run time for each entry of a particular user code.

During operation of the security system a user code is entered on the display screen of the controller to gain access to the gas fueled device. Once a correct user code has been entered, the controller displays one or more safety prompts on the display screen to which the user must confirm on the display screen before the controller enables use of the gas fueled device. If the prompt or prompts have been confirmed, the controller causes the gas valve to open and enable the flow of gas from the gas source to the gas fueled device. A run timer begins monitoring the time since the correct user code has been entered, and at the conclusion of the specified amount of time, the controller causes the gas valve to close and inhibit the flow of gas from the gas source to the gas fueled device, thereby shutting down the gas fueled device. At this point, the same user may re-enter the user code to utilize the gas fueled device again or a different user may enter a user code to utilize the gas fueled device.

Although generally described herein as being utilized with a gas grill, it is contemplated that the security system described in detail herein may be utilized with any suitable gas fueled device, such as a gas grill, a gas firepit, a gas heater, an indoor gas appliance, an outdoor gas light, etc.

Embodiments of the present disclosure are now described in detail with reference to the drawings in which like reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

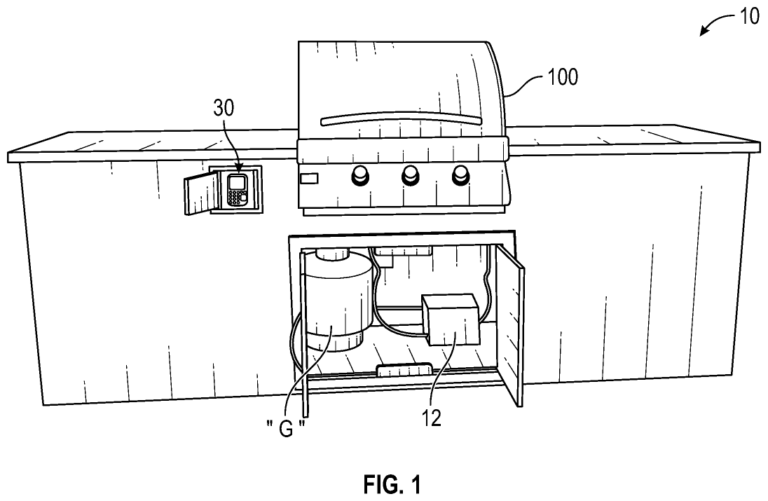

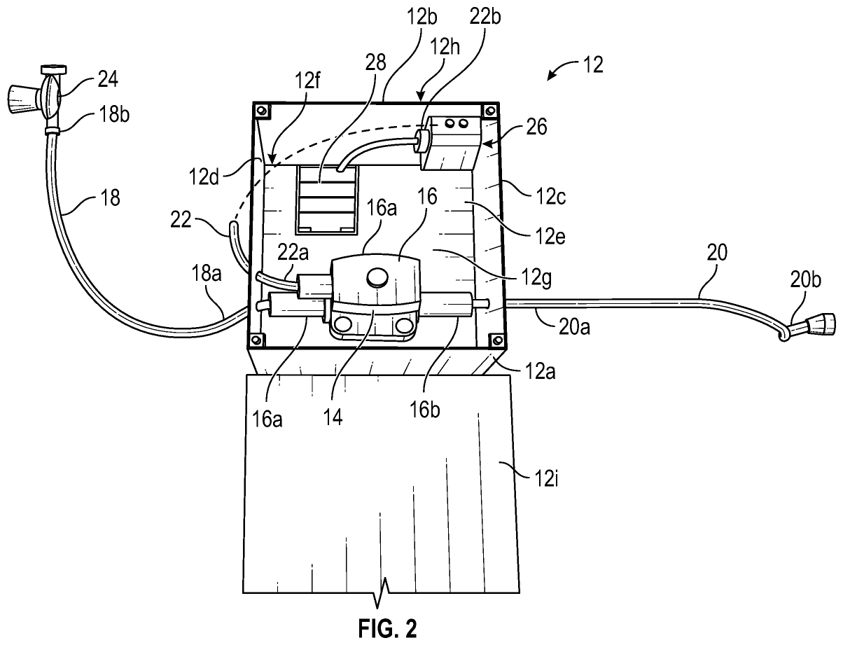

Referring now to the drawings, a security system for gas fueled devices is illustrated and generally identified by reference numeral 10. As illustrated in FIGS. 1 and 2, the security system 10 includes a control housing 12, a shut-off valve 14, an electrical relay 26, a battery 26, and a controller 30. In embodiments, the control housing may include a gas sensor (not shown) for sensing a gas leak or the like. The control housing 12 may be any suitable outdoor rated enclosure for housing electrical and/or electromechanical components therein, such as an enclosure meeting National Electrical Manufacturers Association (NEMA) standards for outdoor use, an enclosure meeting Ingress Protection Code (IP) for outdoor use, etc. and may be formed from any suitable material, such as metallic materials, non-metallic materials, etc. In embodiments, the control housing 12 may not be rated for outdoor use or ingress/egress protection, and in one non-limiting embodiment, the control housing 12 is formed from stainless steel and is ventilated.

The control housing 12 defines a pair of opposed end walls 12a and 12b extending between a corresponding pair of opposed side walls 12c and 12d, respectively. A bottom surface 12e extends between each of the pair of opposed end walls 12a, 12b and the pair of opposed side walls 12c, 12d, and is disposed adjacent a bottom portion 12f of the control housing 12 such that a cavity 12g is defined therein. The control housing 12 includes a selectively removable cover or lid 16 that includes an outer dimension that is similar to that of an outer dimension defined by the pair of opposed end walls 12a, 12b and pair of opposed side walls 12c, 12d. It is contemplated that the removable cover 16 may be selectively secured to an upper portion 12f of the control housing 12 using any suitable means, such as hinges, fasteners, adhesives, etc. In one non-limiting embodiment, the removable cover 12i is selectively fastened to the pair of opposed end walls 12a, 12b and the pair of opposed side walls 12c, 12d using one or more screws or bolts (not shown).

The shut-off valve 14 is disposed within the cavity 12g of the control housing 12 and is selectively secured to the bottom surface 12e using any suitable means, such as mechanical fasteners, adhesives, etc. The shut-off valve 14 is a valve suitable for use with natural gas, propane gas, etc. and in embodiments, is an electromechanical (e.g., motorized) ball valve capable of operating using a 12 Volt or 24 Volt signal. The shut-off valve 14 includes a valve portion 16, a gas supply hose 18, a gas outlet hose 20, and control wires 22. The valve portion 16 defines a housing 16a extending between an inlet portion 16a and an opposite, outlet portion 16b. The valve portion 16 may include a solenoid valve or electric motor (not shown) that is configured to cause the valve portion 16 to transition from a closed position to an open position or vice versa. As can be appreciated, the electric motor is configured to place the valve portion 16 in a normally closed position (e.g., fail closed) to ensure that if electric power to the shut-off valve 14 is lost, the valve portion 16 is returned, or remains, in the closed position thereby inhibiting the flow

The gas supply hose 18 is operably coupled to an inlet portion 16a of the valve portion 16 at a first end portion 18a thereof and is operably coupled to a gas source “G” (FIG. 1) at a second, opposite end portion 18b thereof such that gas is permitted to flow from the gas source “G” to the valve portion 16. In this manner, the gas supply hose 18 is received within a suitable cut-out, connector, etc. (not shown) that is formed or coupled to a portion of the control housing 12 such that the gas supply hose 18 may pass from within the cavity 12g to an area disposed outside of the cavity 12g of the control housing 12. In embodiments where the gas source “G” is a canister (e.g., propane tank, etc.), a pressure regulator or other suitable connector 24 capable of reducing an inlet pressure of the gas source “G” to a pressure required by a gas fueled device (e.g., grill, fire pit, etc.) 100.

The gas outlet hose 20 is operably coupled to an outlet portion 16b of the valve portion 16 at a first end portion 20a thereof and is operably coupled to the gas fueled device 100 at a second, opposite end portion 20b thereof such that gas is selectively permitted to flow from the valve portion 16 to the gas fueled device 100, as will be described in further detail hereinbelow. In this manner, the gas outlet hose 20 is received within a suitable cut-out, connector, etc. (not shown) that is formed or coupled to a portion of the control housing 12 such that the gas outlet hose 20 may pass from within the cavity 12g to an area disposed outside of the cavity 12g of the control housing 12. It is envisioned that the second end portion 20b of the gas outlet hose 20 may include any suitable coupling (not shown) capable of fluidly coupling the gas outlet hose 20 to the gas fueled device 100, such as a coupling having Male Iron Pipe (MIP) threading or the like.

The control wires 22 are operably coupled to the valve portion 16 of the shut-off valve 14 at a first end portion 22a thereof such that an electronic signal (e.g., a 12V or 24V DC voltage signal) can be transmitted to the electric motor (not shown) and cause the valve portion 16 to transition from the closed position, which inhibits the flow of gas therethrough, to an open position, which permits the flow of gas therethrough. As described hereinabove, the valve portion 16 is a normally closed type valve, although it is contemplated that the valve portion 16 may be a normally open type valve, depending upon the design needs of the security system 10.

A second, opposite end portion 22b of the control wires 22 is operably coupled to the electrical relay 26 such that the electrical relay 26 selectively inhibits, or permits, a 12V or 24V DC signal to be transmitted to the electrical motor of the valve portion 16 to open or close the valve portion 16, as will be described in further detail hereinbelow. It is contemplated that the electrical relay 26 may be a normally open relay or a normally closed relay, depending upon the design needs of the security system 10. The electrical relay 26 is operably coupled to the controller 30. In this manner, the controller 30 selectively supplies 12V or 24V electrical energy to the electrical relay 26 to open or close the shut-off valve 14, as will be described in further detail hereinbelow.

In embodiments, the electrical relay 26 may not receive 12V or 24V electrical energy from the controller 30. It is envisioned that the controller 30 may transmit a low voltage signal to the electrical relay 26 to open or close, and 12V electrical energy is supplied to the electrical relay 26 by the energy storage device 28. The energy storage device 28 is disposed within the cavity 12g of the control housing 12 and is operably coupled to the electrical relay 26 using any suitable means, such as electrical wiring, direct connection, etc. The energy storage device 28 may be any suitable energy storage device configured to store and deliver electrical energy, and in embodiments, the energy storage device 28 is a 12V battery. It is envisioned that the energy storage device may be any suitable battery, such as lead acid, lithium-ion, nickel-metal hydride, gel, etc. and in embodiments, the energy storage device 28 may be rechargeable.

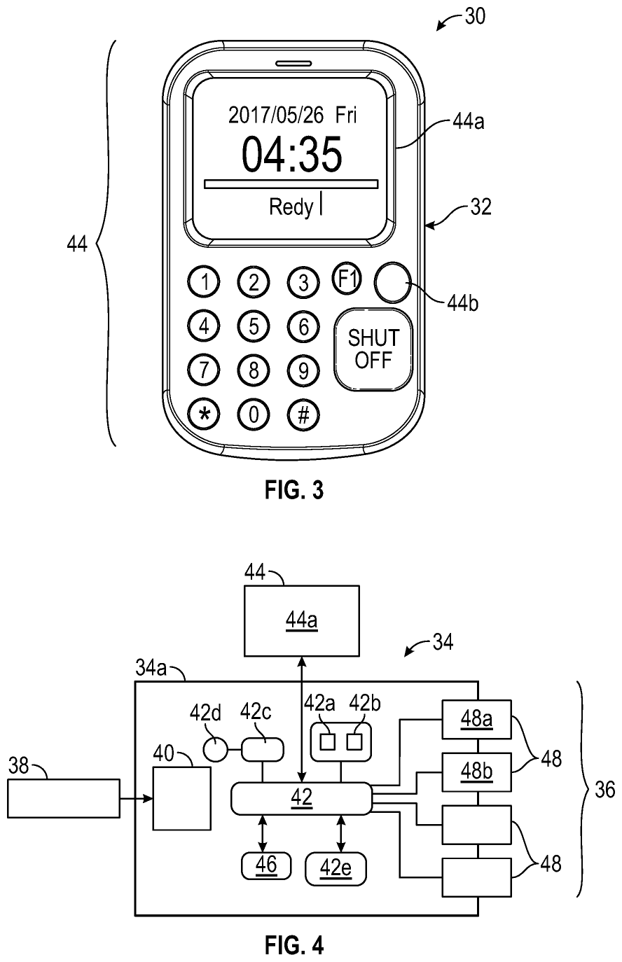

Turning to FIGS. 3 and 4, the controller 30 includes a housing 32 in which a control board 34 is disposed. The control board 34 includes a printed circuit board (PCB) 34a having a plurality of components 36 operably coupled thereto. It is contemplated that the PCB 34a may be any suitable PCB board, and in embodiments, may be a rigid PCB, a flexible PCB, etc. The plurality of components 36 includes a power input 38, a power converter 40, a microcontroller 42, a user interface 44, a wireless transmitter 46, and one or more relays 48.

The power input 38 is configured to receive electrical energy from an energy source (not shown), such as an electrical outlet, an electrical panel, etc. It is contemplated that the power input 38 may be any suitable connector configured to receive electrical energy, such as a male receptacle, a terminal block, a NEMA connector, a MTh connector, etc., and in embodiments, the power input 38 may include an electrical power cord (not shown) having a male plug (not shown) that is operably coupled to the power input 38. The power input 38 is configured to receive residential voltage (e.g., nominal 120V, 115V, 220V, etc.) corresponding to the region in which the security system 10 is intended to be utilized. In one non-limiting embodiment, the power input 38 is configured to receive 115V Alternating Current (AC) electrical energy.

The power input 38 is operably coupled to the power converter 40 which includes at least a transformer (not shown) and a rectifier (not shown). The transformer and rectifier cooperate to transform the 115 VAC electrical energy received by the power input 38 to a DC voltage that is usable by one or more of the plurality of components 36. In embodiments, the power converter 40 transforms the 115 VAC electrical energy to electrical energy between 3.6-5 VDC, although it is contemplated that the power converter 40 may transform the 115 VAC electrical energy into any suitable electrical energy, depending upon the design needs of the security system 10.

The microcontroller 42 is in electrical communication with the power converter 40 and includes a processor 42a associated with a memory 42b. The microcontroller is operably coupled to the user interface 44, the wireless interface 46, and the one or more relays 48. The processor 42a of the microcontroller is configured to receive data from the user interface 44 to effectuate one or more functions based upon instructions stored on the memory 42b. The memory 42b of the microcontroller 42 may include any computer memory, e.g., RAM or ROM, mass storage media, removable storage media and combinations thereof, or any other suitable computer-readable storage medium. The microcontroller 42 is operably coupled to a real-time clock 42c, which in turn, is operably coupled to an energy storage device 42d, such as a battery. The real-time clock 42c and the energy storage device 42d cooperate to maintain a normal state of the microcontroller 42 in the event the electrical energy supplied to the power input 38 is interrupted (e.g., acts as an emergency back-up power).

The user interface 44 includes a display 44a and a plurality of buttons or sensors 44b operably coupled thereto. It is envisioned that the display 44 may be a Liquid Crystal Display (LCD), a Light Emitting Diode (LED) display, an Organic LED (OLED) display, etc. and is configured to display information to a user. In embodiments, the display 44a may be a touch-screen display on which the plurality of buttons 44b may be displayed. In this manner, each of the plurality of buttons 44b may be actuated on the display 44a to effectuate various functions associated with instructions stored on the memory 42b of the microcontroller 42. It is envisioned that the plurality of buttons 44b may be physical buttons disposed within a portion of the housing 32 of the controller 30. It is contemplated that one or more of the plurality of buttons 44b may be backlit using one or more LEDs or the like and

The wireless transmitter 46 may be any suitable wireless transmitter capable of wirelessly transmitting communication data to a remote computer or user device (not shown), such as a Bluetooth® transmitter conforming to IEEE standards or any other suitable wireless protocol, such as WiFi, etc. The wireless transmitter 46 is in electrical communication with the microcontroller 42, such that information pertaining to the operation of the security system 10 that is collected by the processor 42b may be wirelessly transmitted by the wireless transmitter 48 to a remote computer or user device. In this manner, alarms and/or messages generated by the processor 42b of the microcontroller 42 are wirelessly transmitted by the wireless transmitter 48 and received by the computer or user device to alert a user to a fault in the security system 10. In embodiments, the microcontroller 42 may be updated and/or manipulated by a user via the wireless transmitter 46. In one non-limiting embodiment, the microcontroller 42 is operably coupled to a universal serial bus (USB) port 42e that is accessible by a computer or user device to monitor and/or update the microcontroller 42 as needed.

The one or more relays 48 are operably coupled to, and selectively actuatable by, the microcontroller 42. The one or more relays 48 may be any suitable relay and may be a normally open or a normally closed relay depending upon the design needs of the security system 10. The one or more relays 48 include a first relay 48a and a second relay 48b. The first relay 48a is operably coupled to the power input 38, the microcontroller 42, and a power input (not shown) of the gas fueled device 100. In this manner, actuation of the first relay 48a by the microcontroller 42 causes 115 VAC electrical energy to be transmitted from the power input 38 to the power input of the gas fueled device 100. The second relay 48b is operably coupled to the power converter 40, the microcontroller 42, and the electrical relay 26 of the control housing 12. In this manner, actuation of the second relay 48b by the microcontroller 42 causes a control signal between 9 VDC and 24 VDC to be transmitted to the electrical relay 26, which in turn, provides 12 VDC electrical energy to be provided to the shut-off valve 14. In embodiments where the control housing 12 includes the energy storage device 28, it is envisioned that actuation of the second relay 48b transmits a low voltage signal to the electrical relay 26 to open or close, and 12V electrical energy is supplied to the electrical relay 26 by the energy storage device 28. It is contemplated that the one or more relays 48 may include additional relays for various future functions which may be normally open or normally closed relays depending upon the design needs of the security system 10.

The housing 32 of the controller 30 is configured to be received within a single gang electrical box (FIG. 1) (e.g., NEMA enclosure, etc.), or in embodiments, may be coupled to an exterior portion of a single gang electrical box using a suitable adapter or the like. It is envisioned that the housing 32 may be outdoor rated to NEMA or IP specifications and suitable for temperatures between −20° F. and 130° F., although it is contemplated that any suitable temperature range may be utilized. In embodiments, the housing 32 of the controller 30 is rated to IP66 or IP67.

The various settings and functions stored on the memory 42b of the controller 30 are described. The controller 30 enables an administrator to assign a name to the gas fueled device 100 to which the controller is operably coupled. In this manner, the administrator enters a name (e.g., outdoor grill 1, firepit 1, etc.) using the touch screen display 44a of the controller 30, via the wireless transmitter 46 or the USB port 42e. The controller 30 enables the type of device indicative of the gas fueled device 100 to be entered, such as “Electronic Ignition (EI) Fire Pit,” “Gas Grill,” “Gas heater,” etc. The controller 30 allows an administrator user name to be entered, and in embodiments, a unique five-digit code to enable access to Bluetooth® and/or keyboard program features. The controller permits the creation of one or more user profiles including information relating to the resident or individual who is being given access to the gas fueled device, such as one or more of the user's first name, last name, phone number, e-mail address, street address, apartment/suite number, city, state, etc. As can be appreciated, the user profile is given a user access code, and in one non-limiting embodiment, the controller 30 is able to store 1000 unique 4-digit access codes (e.g., 0000 to 9999), although it is contemplated that the controller 30 may store more or less unique user codes. In embodiments, the controller 30 permits a user to enter an incorrect user code up to 4 times before the controller 30 locks the gas fueled device 100 for three minutes.

The controller enables a run timer to be set between 1 minute and 12 hours during which time the user may enjoy uninterrupted use of the gas fired device 100. In embodiments, the default run time is set to 30 minutes. In this manner, the run timer will open the shut-off valve 14 and permit gas to flow from the gas source “G” to the gas fueled device 100 to enable use of the gas fueled device 100 and at the conclusion of the assigned run time, the run timer will close the shut-off valve 14 to terminate the flow of gas from the gas source “G” to the gas fueled device 100. The administrator may assign the same or different run time to each user profile. In embodiments, a fire lockout may be set which enables the administrator to designate a time in which any or all users are locked out (e.g., inhibited) from utilizing the gas fueled device 100. It is envisioned that the fire lockout may be set as a time of day, days of the week, individual calendar dates, etc. As can be appreciated, the fire lockout is set to off by default and must be made operational by the administrator during initial set-up or at a later date.

The controller 30 also includes a sleep mode which enables an administrator to lock all user profiles and inhibit users from utilizing the gas fueled device until the administrator inactivates sleep mode (e.g., sets to off). The sleep mode is set to off by default, and must be activated by the administrator. The controller 30 enables the administrator to set-up an operating schedule which allows a time window during which users may utilize the gas fueled device. The operating schedule may be set up as a daily schedule, a weekly schedule, a schedule which excludes certain days, or an auto-run schedule which overrides all user codes. In one non-limiting embodiments, the controller 30 may store up to four schedules, although it is contemplated that any number of schedules may be stored.

The controller 30 permits the programming of an operation mode. In this manner, the administrator may select a program mode, which is the default setting, in which a user may activate the programmed run time based on the active schedule as long as the fire lock out is not set. Alternatively, the administrator may select a manual mode which overrides the program mode and enables a user to turn on the gas fired device by depressing an “enter” key as long as the sleep mode and the fire lock out is not active. In embodiments, a delay period may be set which limits the number of times a user profile may be activated. It is envisioned that the delay period may be any time between 1 minute to 24 hours, although it is contemplated any suitable delay period may be set.

The controller 30 is configured to store and log events in the memory 42b corresponding to the user code, user name, date and/or time, and run time for each entry of a particular user code. It is contemplated that the controller 30 may store this information for up to 30 days, although it is envisioned that the information may be stored for any suitable amount of time. The events stored in the memory 42b may be accessed by a user device or remote computer via the wireless transmitter 46 or the USB port 42e. In this manner, the type of events and the type of information that is to be stored on the memory 42b, and the means by which the events may be accessed (e.g., by wireless transmitter 46, by USB port 42e, etc. and combinations thereof) may be set by the administrator.

It is contemplated that the controller 30 may display various prompts or alarms on the display 44a before, during, and after use of the gas fueled device 100. In embodiments, the controller 30 may display a prompt on the display 44a asking is the fire pit is uncovered, if the key valve is in the off position, if the grill knows are in the off position, etc. The controller 30 will instruct the user the press the “enter” key to indicate that the answer to the indicated prompt is yes and permit use of the gas fueled device 100.

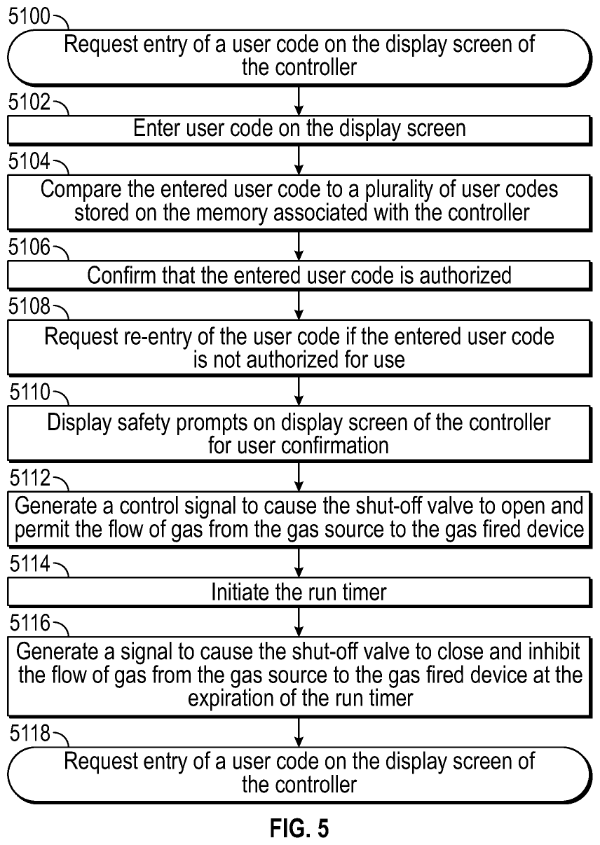

Turning to FIG. 5, the operation of the security system 10 is illustrated. In step S100, the controller 30 requests entry of a user code on the display screen 44a. In step S102, the user code is entered on the display screen 44a, and thereafter, in step S104, the entered user code is compared against a plurality of authorized user codes stored in the memory 42b associated with the controller. In step S106, the controller confirms that the entered user code is authorized. If the entered user code is not authorized, in step S108, the controller 30 requests a user to re-enter the user code.

Once a correct user code has been entered, the controller 30 displays one or more safety prompts on the display screen 44a in step S110 to which the user must confirm on the display screen 44a before the controller enables use of the gas fueled device 100. If the prompt or prompts displayed in step S110 have been confirmed, the controller 30 actuates the second relay 48b in step S112 to provide a control signal to the electrical relay 26 of the control housing 12, which in turn, causes the shut-off valve 14 to open and enable the flow of gas from the gas source “G” to the gas fueled device 100.

In step S114, the run timer begins monitoring the time since the correct user code has been entered, and at the conclusion of the specified amount of time in step S116, the controller 30 actuates the second relay 47b to provide a control signal to the electrical relay 26 of the control housing 12, which in turn, causes the shut-off valve 14 to close and inhibit the flow of gas from the gas source “G” to the gas fueled device 100, thereby shutting down the gas fueled device 100. At this point, in step S118, the same user may re-enter the user code to utilize the gas fueled device 100 again or a different user may enter a user code to utilize the gas fueled device 100.

It will be understood that various modifications may be made to the embodiments of the presently disclosed spinal implant. Therefore, the above description should not be construed as limiting, but merely as exemplifications of embodiments. Those skilled in the art will envision other modifications within the scope and spirit of the present disclosure.

What is claimed is:

1. A security system for a gas fueled device, comprising:
a gas valve, wherein a first end portion of the gas valve is operably coupled to a gas source and a second, opposite end portion of the gas valve is operably coupled to a gas fueled device; and
a controller operably coupled to the gas valve, the controller including a processor operably coupled to a memory, the memory storing instructions, which when executed, cause the processor to:
request entry of a user code;
confirm that the entered user code is authorized for use by comparing the entered user code to a plurality of authorized user codes stored on the memory; and
generate a signal to cause the gas valve to open and permit the flow of gas from the gas source to the gas fueled device if the entered user code is authorized for use.

2. The security system according to claim 1, wherein the gas valve is a motorized ball valve.

3. The security system according to claim 1, wherein the controller is disposed remote from the gas valve.

4. The security system according to claim 1, wherein the controller includes a wireless interface configured to selectively communicate with a user device.

5. The security system according to claim 1, wherein the controller includes a user interface having a display screen.

6. The security system according to claim 5, wherein the display screen is a touch screen.

7. The security system according to claim 1, wherein the gas fueled device is selected from the group consisting of a gas grill, a gas fire pit, a gas heater, an indoor gas appliance, and an outdoor gas light.

8. The security system according to claim 1, wherein the instructions stored on the memory associated with the controller include a run timer, wherein expiration of a predetermined amount of time associated with the run timer causes the processor to generate a signal to cause the gas valve to close and inhibit the flow of gas from the gas source to the gas fueled device.

9. The security system according to claim 1, wherein the controller includes a plurality of relays operably coupled to the processor and the gas valve.

10. A method of using a security system for a gas fueled device, comprising:
requesting entry of a user code on a controller;
comparing the entered user code to a plurality of user codes stored on a memory associated with the controller;
confirming that the entered user code is authorized for use; and
generating a signal to cause a gas valve operably coupled to the controller to open and permit the flow of gas from a gas source to a gas fueled device if the entered user code is authorized for use.

11. The method according to claim 10, further including inhibiting use of the gas fueled device if the entered user code is not confirmed as being authorized for use.

12. The method according to claim 11, further comprising requesting re-entry of a user code if the entered user code is not confirmed as being authorized for use.

13. The method according to claim 10, further comprising initiating a run timer, wherein expiration of a predetermined amount of time associated with the run timer causes the processor to generate a signal to cause the gas valve to close and inhibit the flow of gas from the gas source to the gas fueled device.

14. The method according to claim 1, wherein generating a signal to cause the gas valve to open includes generating a signal to cause the gas valve to open and permit the flow of gas from the gas source to a gas grill if the entered user code is authorized for use.

15. The method according to claim 1, wherein generating a signal to cause the gas valve to open includes generating a signal to cause the gas valve to open and permit the flow of gas from the gas source to a gas firepit if the entered user code is authorized for use.

16. A method of using a security system for a gas fueled device, comprising:
requesting entry of a user code on a controller;
confirming that the entered user code is authorized for use;
initiating a run timer if the entered code is confirmed as being authorized for use;
generating a signal to cause a gas valve operably coupled to the controller to open and permit the flow of gas from a gas source to a gas fueled device; and
generating a signal to cause the gas valve to close and inhibit the flow of gas from the gas source to the gas fueled device at the expiration of a predetermined amount of time associated with the run timer.

17. The method according to claim 16, further including inhibiting use of the gas fueled device if the entered user code is not confirmed as being authorized for use.

18. The method according to claim 17, further comprising requesting re-entry of a user code if the entered user code is not confirmed as being authorized for use.

19. The method according to claim 16, wherein generating a signal to cause the gas valve to open includes generating a signal to cause the gas valve to open and permit the flow of gas from the gas source to a gas grill if the entered user code is authorized for use.

20. The method according to claim 16, wherein generating a signal to cause the gas valve to open includes generating a signal to cause the gas valve to open and permit the flow of gas from the gas source to a gas firepit if the entered user code is authorized for use.
